(19) United States
(12) Patent Application Publication
(10) Pub. No.: US 2026/0213235 A1
(43) Pub. Date: Jul. 23, 2026

(54) FUEL CELL SYSTEM, WORK VEHICLE, AND CONTROL METHOD

(71) Applicant: KOMATSU LTD., Tokyo (JP)

(72) Inventor: Yuki ONO, Tokyo (JP)

(73) Assignee: KOMATSU LTD., Tokyo (JP)

(21) Appl. No.: 19/140,339

(22) PCT Filed: Jan. 19, 2024
(86) PCT No.: PCT/JP2024/001528

§ 371 Date: Jun. 17, 2025

(30) Foreign Application Priority Data
Jan. 19, 2023 (JP) 2023-006582

(51) Int. Cl. H01M 8/04746; H01M 8/04082; H01M 8/04089

(52) U.S. Cl. CPC H01M 8/04753; H01M 8/04089; H01M 8/04201; H01M 2250/20

(57) ABSTRACT

A first hydrogen storage unit stores hydrogen and has a first filling port that is a hydrogen filling port. A second hydrogen storage unit stores hydrogen and has a second filling port that is a hydrogen filling port. A fuel cell generates power using hydrogen. A pipe connects the first hydrogen storage unit, the second hydrogen storage unit, and the fuel cell to each other, and allows circulation of hydrogen. A valve is provided between the first hydrogen storage unit and the second hydrogen storage unit in the pipe. The valve has a configuration capable of preventing circulation of hydrogen between the first hydrogen storage unit and the second hydrogen storage unit.

### TECHNICAL FIELD

The present disclosure relates to a fuel cell system, a work vehicle, and a control method.

The present application claims priority to JP 2023-006582 A filed in Japan on Jan. 19, 2023, the contents of which are incorporated herein by reference.

### BACKGROUND ART

Work vehicles equipped with fuel cells using hydrogen gas as a fuel have been studied. Patent Literature 1 discloses a technology for filling a tank with hydrogen using a plurality of hydrogen feeders in order to shorten a filling time.

### PRIOR ART LITERATURE

### Patent Literature

Patent Literature 1: JP 2022-107351 A

### SUMMARY OF INVENTION

### Technical Problem

However, in the case of hydrogen filling using a plurality of hydrogen feeders, when the hydrogen feeders differ from each other in pressure, there is a possibility that hydrogen fed from one hydrogen feeder flows back to another hydrogen feeder, thereby overloading the hydrogen feeder.

It is an object of the present disclosure to provide a fuel cell system, a work vehicle, and a control method capable of quickly achieving hydrogen filling while protecting a hydrogen feeder.

### Means for Solving Problem

According to one aspect of the present invention, a fuel cell system includes: a first hydrogen storage unit that stores hydrogen and has a first filling port that is a hydrogen filling port; a second hydrogen storage unit that stores hydrogen and has a second filling port that is a hydrogen filling port; a fuel cell that generates power using hydrogen; a pipe that connects the first hydrogen storage unit, the second hydrogen storage unit, and the fuel cell to each other, and allows circulation of hydrogen; and a valve provided between the first hydrogen storage unit and the second hydrogen storage unit in the pipe, the valve being capable of preventing circulation of hydrogen between the first hydrogen storage unit and the second hydrogen storage unit.

### Effects of Invention

According to the above aspect, the fuel cell system can quickly achieve hydrogen filling while protecting a hydrogen feeder.

### BRIEF DESCRIPTION OF DRAWINGS

FIG. 1 is a perspective view schematically illustrating a transportation vehicle according to a first embodiment.

FIG. 2 is a schematic block diagram illustrating a configuration of a power system and a drive system included in the transportation vehicle according to the first embodiment.

FIG. 3 is a diagram illustrating a configuration of a hydrogen storage unit according to the first embodiment.

FIG. 4 is a schematic block diagram illustrating a configuration of a control device included in the transportation vehicle according to the first embodiment.

FIG. 5 is a flowchart illustrating hydrogen filling processing of the transportation vehicle according to the first embodiment.

FIG. 6 is a schematic block diagram illustrating a configuration of a computer according to at least one embodiment.

### DESCRIPTION OF EMBODIMENTS

### First Embodiment

### <<Configuration of Transportation Vehicle 10>>

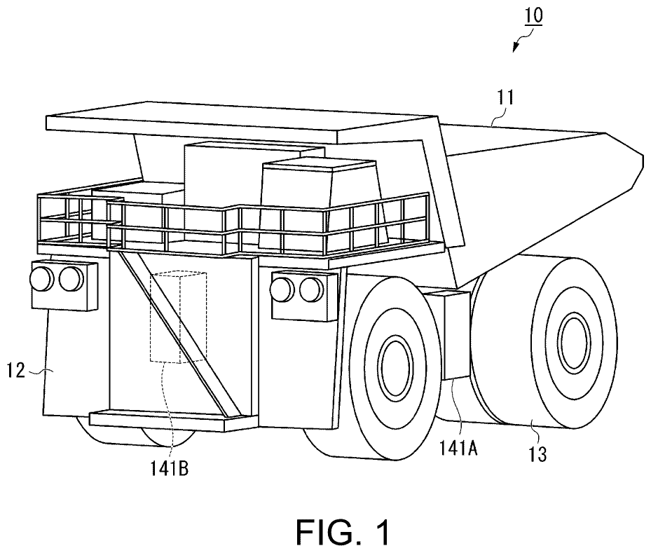

FIG. 1 is a perspective view schematically illustrating a transportation vehicle 10 according to a first embodiment. The transportation vehicle 10 includes a dump body 11, a vehicle body 12, and a traveling device 13.

The dump body 11 is a member on which a load is loaded. At least a part of the dump body 11 is disposed above the vehicle body 12. The dump body 11 performs a dumping operation and a lowering operation. The dump body 11 is adjusted to a dumping posture and a loading posture by the dumping operation and the lowering operation. The dumping posture refers to a posture in which the dump body 11 is raised. The loading posture refers to a posture in which the dump body 11 is lowered.

The vehicle body 12 includes a vehicle body frame. The vehicle body 12 supports the dump body 11. The vehicle body 12 is supported by the traveling device 13.

The traveling device 13 supports the vehicle body 12. The traveling device 13 causes the transportation vehicle 10 to travel. The traveling device 13 moves the transportation vehicle 10 forward or backward. At least a part of the traveling device 13 is disposed below the vehicle body 12. The traveling device 13 includes a pair of front wheels and a pair of rear wheels. The front wheels are steering wheels, and the rear wheels are driving wheels. Note that the combination of the steering wheels and the driving wheels is not limited thereto, and the traveling device 13 may be four-wheel drive or four-wheel steering.

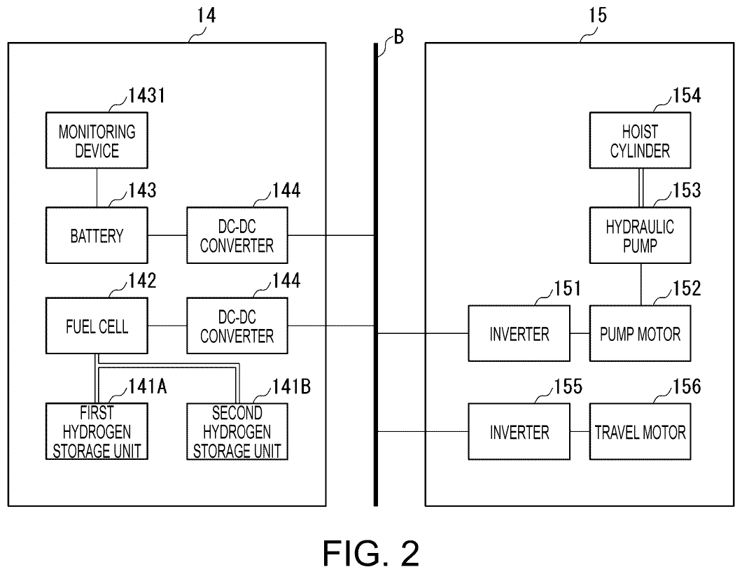

FIG. 2 is a schematic block diagram illustrating a configuration of a power system 14 and a drive system 15 included in the transportation vehicle 10 according to the first embodiment. The power system 14 includes two hydrogen storage units 141, a fuel cell 142, a battery 143, and a DC-DC converter 144.

The hydrogen storage units 141 store hydrogen, and feed the stored hydrogen to the fuel cell. The fuel cell 142 generates power by electrochemically reacting hydrogen fed from the hydrogen storage units 141 with oxygen contained in outside air. The transportation vehicle 10 includes the two hydrogen storage units 141 (a first hydrogen storage unit 141A and a second hydrogen storage unit 141B). The first hydrogen storage unit 141A is provided on the left side of the vehicle body 12, and the second hydrogen storage unit 141B is provided on the right side of the vehicle body 12.

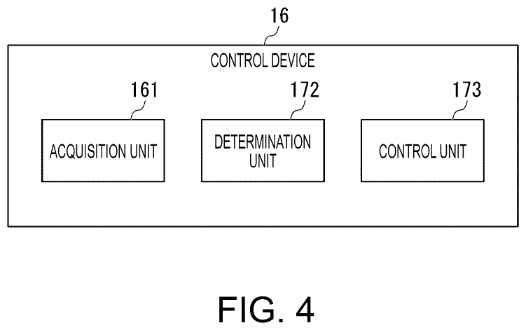

The battery 143 stores the power generated in the fuel cell 142. The DC-DC converter 144 outputs the power from the fuel cell 142 or the battery 143 connected in accordance with an instruction from a control device 16 (see FIG. 4). The battery 143 is provided with a monitoring device 1431 to monitor a charging rate of the battery 143.

The power output from the power system 14 is output to the drive system 15 via a bus B. The drive system 15 includes an inverter 151, a pump motor 152, a hydraulic pump 153, a hoist cylinder 154, an inverter 155, and a travel motor 156. The inverter 151 converts a direct current from the bus B into a three-phase alternating current and supplies the three-phase alternating current to the pump motor 152. The pump motor 152 drives the hydraulic pump 153. Hydraulic oil discharged from the hydraulic pump 153 is supplied to the hoist cylinder 154 via a control valve (not illustrated). When the hydraulic oil is supplied to the hoist cylinder 154, the hoist cylinder 154 is operated. The hoist cylinder 154 causes the dump body 11 to perform a dumping operation or a lowering operation. The inverter 155 converts the direct current from the bus B into a three-phase alternating current and supplies the three-phase alternating current to the travel motor 156. Torque generated by the travel motor 156 is transmitted to the driving wheels of the traveling device 13.

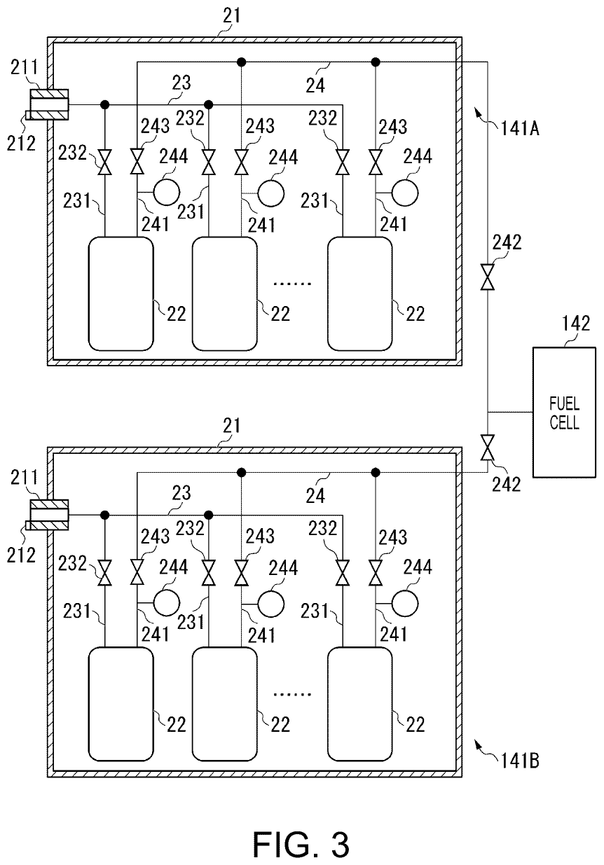

FIG. 3 is a diagram illustrating a configuration of the hydrogen storage units 141 according to the first embodiment.

Each of the first hydrogen storage unit 141A and the second hydrogen storage unit 141B includes a housing 21, a plurality of hydrogen tanks 22, a first pipe 23, and a second pipe 24. The housing 21 houses the plurality of hydrogen tanks 22, the first pipe 23, and the second pipe 24. The housing 21 is provided with a filling port 211 that receives an input of hydrogen from a hydrogen feeding device (not illustrated). The filling port 211 is provided with a connection sensor 212 that detects connection with the feeding device. Each of the plurality of hydrogen tanks 22 is an example of a hydrogen storage device.

The first pipe 23 connects the filling port 211 and each hydrogen tank 22. The filling port 211 is connected to the upstream side of the first pipe 23, and the plurality of hydrogen tanks 22 is connected to the downstream side. The first pipe 23 and each hydrogen tank 22 are connected via a first branch pipe 231. Each first branch pipe 231 is provided with a first control valve 232.

The second pipe 24 connects each hydrogen tank 22 and the fuel cell 142. The first hydrogen storage unit 141A and the second hydrogen storage unit 141B are connected to each other via the second pipe 24. The plurality of hydrogen tanks 22 is connected to the upstream side of the second pipe 24, and the fuel cell 142 is connected to the downstream side. The second pipe 24 and each hydrogen tank 22 are connected via a second branch pipe 241. On the upstream side of the second pipe 24, a header valve 242, which is a control valve (on-off valve), is provided. Each second branch pipe 241 is provided with a second control valve 243 and a tank sensor 244. The tank sensor 244 measures the pressure and temperature of the hydrogen tank 22.

The transportation vehicle 10 includes the control device 16 that controls the power system 14. FIG. 4 is a schematic block diagram illustrating a configuration of the control device 16 included in the transportation vehicle 10 according to the first embodiment.

The control device 16 includes an acquisition unit 161, a determination unit 172, and a control unit 173.

The acquisition unit 161 acquires measurement data from the monitoring device 1431, the connection sensors 212, and the tank sensors 244.

On the basis of the measurement data acquired by the acquisition unit 161, the determination unit 172 determines the hydrogen storage unit 141 to be a hydrogen filling target and the hydrogen storage unit 141 to be a hydrogen release target.

The control unit 173 controls opening and closing of the first control valves 232, the second control valves 243, and the header valves 242. The control unit 173 closes the second control valves 243 and opens the first control valves 232 of the hydrogen storage unit 141 to be a filling target. In a case where both the first hydrogen storage unit 141A and the second hydrogen storage unit 141B are connected with feeding devices, the control unit 173 closes the header valves 242 of the first hydrogen storage unit 141A and the second hydrogen storage unit 141B so as to prevent backflow of hydrogen into the feeding devices. Furthermore, the control unit 173 closes the first control valves 232, and opens the second control valves 243 and the header valve 242 of the hydrogen storage unit 141 to be the release target.

In addition, on the basis of measurement data from the tank sensors 244 acquired by the acquisition unit 161, the control unit 173 closes the first control valve 232 of the hydrogen tank 22 having a temperature or pressure higher than a threshold.

### <<Filling Processing>>

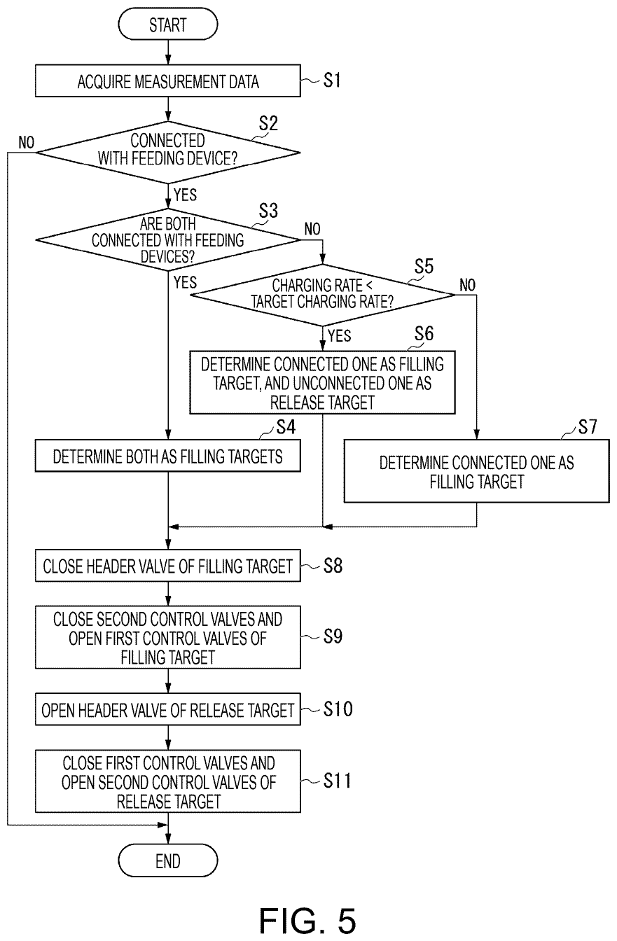

FIG. 5 is a flowchart illustrating hydrogen filling processing of the transportation vehicle 10 according to the first embodiment.

First, the acquisition unit 161 of the control device 16 acquires measurement data from the monitoring device 1431, the connection sensors 212, and the tank sensors 244 (step S1). That is, the acquisition unit 161 acquires measurement data regarding the charging rate of the battery 143, whether a feeding device is connected, and the pressure and temperature of each hydrogen tank 22. The determination unit 172 determines whether at least one of the filling ports 211 is connected with a feeding device on the basis of the measurement data from the connection sensors 212 (step S2). If none of the filling ports 211 is connected with a feeding device (step S2: NO), the determination unit 172 determines not to perform filling with hydrogen, and ends the processing.

On the other hand, if at least one of the filling ports 211 is connected with a feeding device (step S2: YES), the determination unit 172 determines whether the filling ports 211 of both the first hydrogen storage unit 141A and the second hydrogen storage unit 141B are connected with feeding devices (step S3).

If the filling ports 211 of both the first hydrogen storage unit 141A and the second hydrogen storage unit 141B are connected with feeding devices (step S3: YES), the determination unit 172 determines both the first hydrogen storage unit 141A and the second hydrogen storage unit 141B as filling targets (step S4).

On the other hand, if only the filling port 211 of one of the first hydrogen storage unit 141A and the second hydrogen storage unit 141B is connected with a feeding device (step S3: NO), the determination unit 172 determines whether the charging rate of the battery 143 is less than a predetermined target charging rate on the basis of the measurement data from the monitoring device 1431 (step S5). If the charging rate of the battery 143 is less than the predetermined target charging rate (step S5: YES), the determination unit 172 determines, as a filling target, the hydrogen storage unit 141 to which the feeding device is connected, and determines, as a release target, the hydrogen storage unit 141 to which no feeding device is connected (step S6).

If the charging rate of the battery 143 is equal to or higher than the predetermined target charging rate in step S7 (step S5: NO), the determination unit 172 determines, as a filling target, the hydrogen storage unit 141 to which the feeding device is connected (step S7). At this time, the hydrogen storage unit 141 to which no feeding device is connected is neither a filling target nor a release target.

The control unit 173 closes the header valve 242 of the hydrogen storage unit 141 to be the filling target (step S8). Then, the control unit 173 closes the second control valves 243 and opens the first control valves 232 of the hydrogen storage unit 141 to be the filling target (step S9). As a result, hydrogen is fed to the hydrogen storage unit 141 to be the filling target. In addition, it is possible to prevent hydrogen fed from the feeding device from flowing into the other hydrogen storage unit 141. Furthermore, the control unit 173 opens the header valve 242 of the hydrogen storage unit 141 to be the release target (step S10). Then, the control unit 173 closes the first control valves 232 and opens the second control valves 243 of the hydrogen storage unit 141 to be the release target (step S11). In a case where there is no hydrogen storage unit 141 to be a release target, the processing of step S10 and step S11 may not be performed. The control unit 173 controls the DC-DC converter 144 to charge the battery 143 with electricity generated by operation of the fuel cell 142.

### <<Operation and Effect>>

As described above, the transportation vehicle 10 according to the first embodiment includes the first hydrogen storage unit 141A and the second hydrogen storage unit 141B, and closing the header valves 242 prevents circulation of hydrogen between the first hydrogen storage unit 141A and the second hydrogen storage unit 141B. This allows the transportation vehicle 10 to prevent circulation of hydrogen from one feeding device to the other feeding device even in a case where the filling ports 211 of both the first hydrogen storage unit 141A and the second hydrogen storage unit 141B are connected with feeding devices. Therefore, the transportation vehicle 10 according to the first embodiment can quickly achieve hydrogen filling while protecting a hydrogen feeder.

Furthermore, in a case where only one hydrogen storage unit 141 is connected with a feeding device, the transportation vehicle 10 according to the first embodiment can operate the fuel cell 142 using hydrogen in the other hydrogen storage unit 141 to charge the battery 143, while filling the one hydrogen storage unit 141 with hydrogen. This allows the transportation vehicle 10 to increase efficiency by operating the fuel cell 142 while performing hydrogen filling.

### OTHER EMBODIMENTS

Although one embodiment has been described above in detail with reference to the drawings, the specific configuration is not limited to the above-described configuration, and various design changes and the like can be made. That is, in another embodiment, the order of the above-described processing may be appropriately changed. In addition, some pieces of the processing may be executed in parallel.

In the above-described embodiment, the first pipe 23 for filling of hydrogen from a feeding device and the second pipe 24 for releasing hydrogen into the fuel cell 142 are separately provided, but the present disclosure is not limited thereto. For example, in another embodiment, a common pipe may be used for filling of hydrogen from the feeding device and for releasing of hydrogen into the fuel cell 142. In this case, in a case where only one hydrogen storage unit 141 is connected with a feeding device, the control device 16 may open the header valves 242 of both hydrogen storage units 141 to feed hydrogen to both hydrogen storage units 141. That is, the header valves 242 are only required to close when the filling ports of both hydrogen storage units 141 are connected with feeding devices.

The header valves 242 according to the above-described embodiment are openable and closable control valves, but are not limited thereto. For example, the header valves 242 according to another embodiment may be check valves that prevent inflow of hydrogen from the fuel cell 142 side.

In the above-described embodiment, the transportation vehicle 10 includes two hydrogen storage units 141, but the present disclosure is not limited thereto. For example, in another embodiment, the transportation vehicle 10 may include three or more hydrogen storage units 141.

### <Computer Configuration>

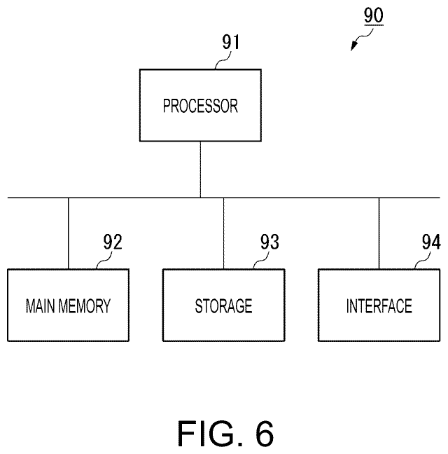

FIG. 6 is a schematic block diagram illustrating a configuration of a computer according to at least one embodiment. A computer 90 includes a processor 91, a main memory 92, a storage 93, and an interface 94.

The control device 16 described above is implemented in the computer 90. Then, the operation of each processing unit described above is stored in the storage 93 in the form of a program. The processor 91 reads the program from the storage 93, develops the program in the main memory 92, and executes the above processing according to the program. In addition, the processor 91 secures a storage area corresponding to each storage unit described above in the main memory 92 according to the program. Examples of the processor 91 include a central processing unit (CPU), a graphic processing unit (GPU), and a microprocessor.

The program may be for implementing some of the functions to be exerted by the computer 90. For example, the program may exhibit a function by a combination with another program already stored in the storage or a combination with another program implemented in another device. Note that, in another embodiment, the computer 90 may include a custom large scale integrated circuit (LSI) such as a programmable logic device (PLD) in addition to or instead of the above configuration. Examples of the PLD include a programmable array logic (PAL), a generic array logic (GAL), a complex programmable logic device (CPLD), and a field programmable gate array (FPGA). In this case, some or all of the functions implemented by the processor 91 may be implemented by the integrated circuit. Such an integrated circuit is also included in examples of the processor.

Examples of the storage 93 include a magnetic disk, a magneto-optical disk, an optical disk, and a semiconductor memory. The storage 93 may be an internal medium directly connected to the bus of the computer 90 or an external medium connected to the computer 90 via the interface 94 or a communication line. Furthermore, in a case where this program is distributed to the computer 90 via the communication line, the computer 90 that has received the distribution may expand the program in the main memory 92 and execute the above processing. In at least one embodiment, the storage 93 is a non-transitory tangible storage medium.

Furthermore, the program may be for implementing some of the functions described above. Furthermore, the program may be a program that implements the above-described functions in combination with another program already stored in the storage 93, that is, a so-called difference file (difference program).

### INDUSTRIAL APPLICABILITY

According to the above aspect, the fuel cell system can quickly achieve hydrogen filling while protecting a hydrogen feeder.

### REFERENCE SIGNS LIST

10 . . . Transportation vehicle
11 . . . Dump body
12 . . . Vehicle body
13 . . . Traveling device
14 . . . Power system
141 . . . Hydrogen storage unit
141A . . . First hydrogen storage unit
141B . . . Second hydrogen storage unit
142 . . . Fuel cell
143 . . . Battery
1431 . . . Monitoring device
144 . . . DC-DC converter
15 . . . Drive system
151 . . . Inverter
152 . . . Pump motor
153 . . . Hydraulic pump
154 . . . Hoist cylinder
155 . . . Inverter
156 . . . Travel motor
16 . . . Control device
161 . . . Acquisition unit
172 . . . Determination unit
173 . . . Control unit
21 . . . Housing
211 . . . Filling port
212 . . . Connection sensor
22 . . . Hydrogen tank
23 . . . First pipe
231 . . . First branch pipe
232 . . . First control valve
24 . . . Second pipe
241 . . . Second branch pipe
242 . . . Header valve
243 . . . Second control valve
244 . . . Tank sensor
90 . . . Computer
91 . . . Processor
92 . . . Main memory
93 . . . Storage
94 . . . Interface
B . . . Bus

1. A fuel cell system comprising:
a first hydrogen storage unit that stores hydrogen and has a first filling port that is a hydrogen filling port;
a second hydrogen storage unit that stores hydrogen and has a second filling port that is a hydrogen filling port;
a fuel cell that generates power using hydrogen;
a pipe that connects the first hydrogen storage unit, the second hydrogen storage unit and the fuel cell to each other, and allows circulation of hydrogen; and
a valve provided between the first hydrogen storage unit and the second hydrogen storage unit in the pipe, the valve being capable of preventing circulation of hydrogen between the first hydrogen storage unit and the second hydrogen storage unit.

2. The fuel cell system according to claim 1, wherein
the valve is an on-off valve that closes when both the first filling port and the second filling port are connected with hydrogen feeding device.

3. The fuel cell system according to claim 2, comprising:
a first on-off valve that is the valve provided between the first hydrogen storage unit and the fuel cell; and
a second on-off valve that is the valve provided between the second hydrogen storage unit and the fuel cell,
wherein
the first on-off valve closes when both the first filling port and the second filling port are connected with hydrogen feeding device and when the first filling port is connected with hydrogen feeding device and hydrogen is fed from the second hydrogen storage unit to the fuel cell, and
the second on-off valve closes when both the first filling port and the second filling port are connected with hydrogen feeding device and when the second filling port is connected with hydrogen feeding device and hydrogen is fed from the first hydrogen storage unit to the fuel cell.

4. A work vehicle comprising the fuel cell system according to claim 1.

5. A control method of controlling a fuel cell system including:
a first hydrogen storage unit that stores hydrogen and has a first filling port that is a hydrogen filling port;
a second hydrogen storage unit that stores hydrogen and has a second filling port that is a hydrogen filling port;
a fuel cell that generates power using hydrogen;
a pipe that connects the first hydrogen storage unit, the second hydrogen storage unit and the fuel cell to each other, and allows circulation of hydrogen; and
an on-off valve provided between the first hydrogen storage unit and the second hydrogen storage unit in the pipe,
wherein the control method comprises:
closing the on-off valve when both the first filling port and the second filling port are connected with hydrogen feeding device.
